(19) United States
(12) Patent Application Publication
(10) Pub. No.: US 2014/0176684 A1
(43) Pub. Date: Jun. 26, 2014

(54) TECHNIQUES FOR MULTIPLE VIEWER THREE-DIMENSIONAL DISPLAY

(71) Applicants: ALEJANDRO VARELA, Phoenix, AZ (US); BRANDON C. BARNETT, Beaverton, OR (US)

(72) Inventors: ALEJANDRO VARELA, Phoenix, AZ (US); BRANDON C. BARNETT, Beaverton, OR (US)

(21) Appl. No.: 13/726,357

(22) Filed: Dec. 24, 2012

(51) Int. Cl. H04N 13/04; G02F 1/13; G02B 27/22

(52) U.S. Cl. CPC H04N 13/0468; G02B 27/2228; G02F 1/1313
USPC 348/51; 359/462; 349/15; 359/463

(57) ABSTRACT

Various embodiments are generally directed toward a viewing device using and steering of collimated light to separately paint detected eye regions of multiple persons to provide them with 3D imagery. A viewing device includes an image panel to cause collimated light to convey multiple pixels of one of a left side frame and a right side frame associated with a frame of 3D imagery, and a steering assembly to steer the collimated light towards an eye to paint an eye region of a face that includes the eye. Other embodiments are described and claimed herein.

### BACKGROUND

Some current three-dimensional (3D) viewing devices are able to provide effective 3D viewing to multiple persons, but only if all of those persons wear specialized eyewear (e.g., prismatic, active shutter-based, bi-color or other form of 3D glasses). Other current viewing devices are able to provide effective 3D viewing without specialized eyewear, but only for one person positioned at a specific location.

Viewing devices supporting 3D viewing by multiple persons frequently employ some form of actively-driven eyewear with liquid-crystal panels positioned in front of each eye that are operated to alternately allow only one eye at a time to see a display. This shuttering of one or the other of the eyes is synchronized to the display of one of a left frame and a right frame on the display such that a view of the left frame is delivered only to the left eye and a view of the right frame is delivered only to the right eye. While this enables 3D viewing by multiple persons, the wearing of such eyewear can be cumbersome, and those who see the display without wearing such eyewear are presented with what appears to be blurry images, since the display is operated to alternately show left and right frames at a high switching frequency coordinated with a refresh rate.

Viewing devices supporting 3D viewing by one person in a manner not requiring specialized eyewear of any form frequently require the one person to position their head at a specific position relative to a display to enable Lenticular lenses and/or other components of the display to simultaneously present left and right frames solely to their left and right eyes, respectively. While this eliminates the discomfort of wearing specialized eyewear, it removes the freedom to be able to view 3D imagery from any other location than the one specific position that provides the optical alignment required with a pair of eyes. Further, depending on the specific technique used, those who see the display from other locations may see a blurry display or a vertically striped interweaving of the left and right images that can be unpleasant to view. It is with respect to these and other considerations that the embodiments described herein are needed.

### BRIEF DESCRIPTION OF THE DRAWINGS

FIG. 1 illustrates a first embodiment of a viewing device.

FIG. 2 illustrates a portion of the embodiment of FIG. 1, depicting aspects of an operating environment.

FIG. 3 illustrates an example of a field of view of a camera of the embodiment of FIG. 1.

FIGS. 4a and 4b each illustrate a portion of the embodiment of FIG. 1, depicting possible implementations of components to paint eye regions to provide 3D imagery.

FIGS. 5a through 5d illustrate a sequence of painting eye regions of multiple persons with light to provide 3D imagery by the embodiment of FIG. 1.

FIGS. 6a through 6c illustrate aspects of steering light by the embodiment of FIG. 1 to paint an eye region.

FIG. 7 illustrates a portion of the embodiment of FIG. 1, depicting another possible implementation of components to paint eye regions to provide 3D imagery.

FIG. 8 illustrates an embodiment of a first logic flow.

FIG. 9 illustrates an embodiment of a second logic flow.

FIG. 10 illustrates an embodiment of a processing architecture.

### DETAILED DESCRIPTION

Various embodiments are generally directed toward techniques for a viewing device using and steering of collimated light to separately paint detected eye regions of multiple persons to provide them with 3D imagery. Facial recognition and analysis are employed to recurringly identify faces and eyes of persons viewing a viewing device to identify left and right eye regions. Collimated light conveying alternating left and right frames of video data are then steered in a recurring order towards the identified left and right regions. In this way, left and right each eye region are painted with collimated light conveying pixels of corresponding ones of the left and right frames.

In identifying faces and eye regions of faces, the viewing device may determine whether identified faces are too far from the location of the viewing device to effectively provide 3D viewing, whether one or both eyes are accessible to the viewing device such that providing 3D viewing is possible, and/or whether the orientation of the face is such that the eyes are rotated too far away from a horizontal orientation to provide 3D viewing in a manner that is not visually confusing. Where a face is too far away, where an eye is inaccessible and/or where a pair of eyes is rotated too far from a horizontal orientation, the viewing device may employ the collimated light to convey the same image to both eyes or to the one accessible eye, thus conveying two-dimensional viewing.

In painting eye regions with collimated light, the viewing device may employ a distinct collimator to create spatially coherent light from any of a variety of light sources. Such a collimator may employ nanoscale apertures possibly formed in silicon using processes often employed in the semiconductor industry to make integrated circuits (ICs) and/or microelectromechanical systems (MEMS) devices. Such collimated light may then be passed through or reflected by one or more image panels, possibly employing a variant of liquid crystal display (LCD) technology, to cause the collimated light to convey alternating left and right frames of a 3D image. Then, such collimated light is steered towards the eyes of viewers of the viewing device, one eye at a time, to paint eye regions with alternating ones of the left and right frames to thereby provide 3D viewing.

In one embodiment, for example, a viewing device includes an image panel to cause collimated light to convey multiple pixels of one of a left side frame and a right side frame associated with a frame of 3D imagery, and a steering assembly to steer the collimated light towards an eye to paint an eye region of a face that includes the eye. Other embodiments are described and claimed herein.

With general reference to notations and nomenclature used herein, portions of the detailed description which follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may comprise a general purpose computer. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

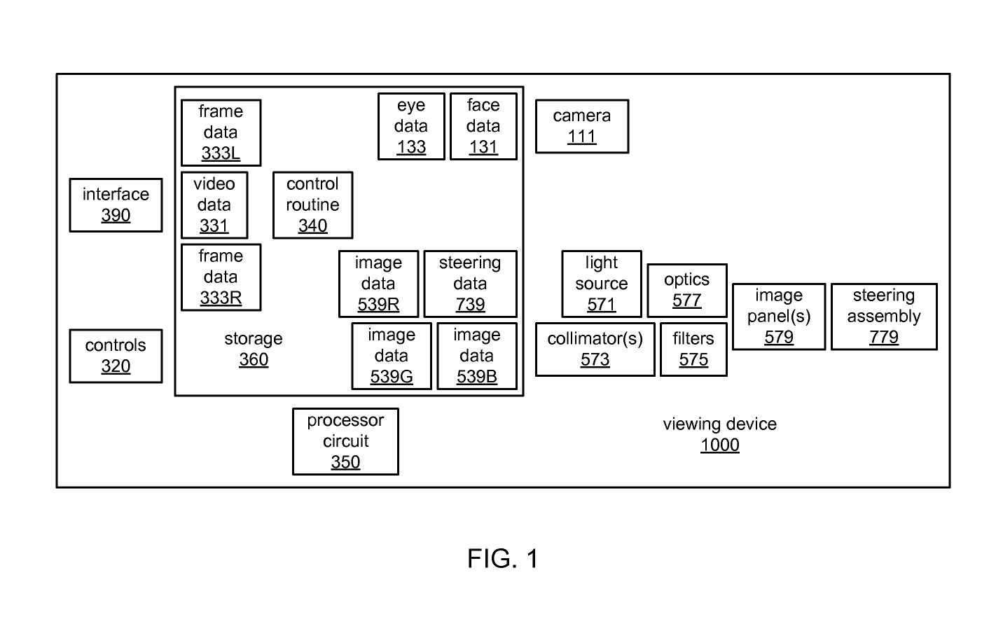

FIG. 1 illustrates a block diagram of a viewing device 1000. The viewing device 1000 may be based on any of a variety of types of computing device, including without limitation, a desktop computer system, a data entry terminal, a laptop computer, a netbook computer, an ultrabook computer, a tablet computer, a handheld personal data assistant, a smartphone, a body-worn computing device incorporated into clothing, a computing device integrated into a vehicle (e.g., a car, a bicycle, a wheelchair, etc.), a server, a cluster of servers, a server farm, etc. However, it is envisioned that viewing device 1000 is a viewing appliance, much like a television, but capable of providing multiple persons with a 3D viewing experience without cumbersome eyewear.

In various embodiments, the viewing device 1000 incorporates one or more of a camera 111, controls 320, a processor circuit 350, a storage 360, an interface 390, a light source 571, collimator(s) 573, filters 575, optics 577, image panel(s) 579, and a steering assembly 779. The storage 360 stores one or more of a face data 131, an eye data 133, a video data 331, frame data 333L and 333R, a control routine 340, a steering data 739, and image data 539R, 539G and 539B.

The camera 111, the controls 320 and the steering assembly 779 are the components that most directly engage viewers operating the viewing device 1000 to view 3D imagery. The camera 111 recurringly captures images of viewers for subsequent face and eye recognition, the controls 320 enable operation of the viewing device 1000 to select 3D imagery to be viewed (e.g., select a TV channel, select an Internet video streaming site, etc.), and the steering assembly 779 recurringly steers collimated light conveying left and right frames of 3D imagery to eye regions of left and right eyes of each of the viewers.

It should be noted that although only one of the camera 111 is depicted, other embodiments are possible in which there are more than one of the camera 111. This may be done to improve the accuracy of facial and/or eye recognition, and/or to enable greater accuracy in determining locations of eye regions. The controls 320 may be made up of any of a variety of types of controls from manually-operable buttons, knobs, levers, etc., (possibly incorporated into a remote control device made to be easily held in one or two hands) to non-tactile controls (e.g., proximity sensors, thermal sensors, etc.) to enable viewers to convey commands to operate the viewing device 1000. Alternatively, the camera 111 (possibly more than one of the camera 111) may be employed to monitor movements of the viewers to enable interpretation of gestures made by the viewers (e.g., hand gestures) that are assigned meanings that convey commands.

As will be explained in greater detail, the collimated light that is steered by the steering assembly 779 is generated by the light source 571 and then collimated by the collimator(s) 573. Various possible combinations of the collimator(s) 573, the filters 575 and the optics 577 then derive three selected wavelengths (or narrow ranges of wavelengths) of collimated light corresponding to red, green and blue colors. Those three selected wavelengths are then separately modified to convey red, green and blue components of left and right frames of 3D imagery by corresponding three separate ones of the image panel(s) 579. These red, green and blue wavelengths of collimated light, now each conveying a red, green or blue component of left and right frames of 3D imagery, are then combined by the optics 577 and conveyed in combined multicolor form to the steering assembly 779. It should be noted that although the camera 111 and each of the light source 571, the collimator(s) 573, the filters 575, the optics 577, the image panel(s) 579 and the steering assembly 779 are depicted as incorporated into the viewing device 1000 itself, alternate embodiments are possible in which these components may be disposed in a separate casing from at least the processor circuit 350 and storage 360.

The interface 390 is a component by which the viewing device 1000 receives 3D video imagery via a network (not shown) and/or RF transmission. In embodiments in which the interface is capable of receiving video imagery via RF transmission, the interface 390 may include one or more RF tuners to receive RF channels conveying video imagery in analog form and/or in a digitally encoded form. In embodiments in which the interface 390 is capable of communication via a network, such a network may be a single network possibly limited to extending within a single building or other relatively limited area, a combination of connected networks possibly extending a considerable distance, and/or may include the Internet. Thus, such a network may be based on any of a variety (or combination) of communications technologies by which signals may be exchanged, including without limitation, wired technologies employing electrically and/or optically conductive cabling, and wireless technologies employing infrared, radio frequency or other forms of wireless transmission. Further, via such a network, the viewing device 1000 may exchange signals with other computing devices (not shown) that convey data that may be entirely unrelated to the receipt of 3D video imagery (e.g., data representing webpages of websites, video conference data, etc.).

In executing at least the control routine 340, the processor circuit 350 is caused to operate the interface 390 to receive frames of 3D video imagery, storing those video frames as the video data 331, and subsequently decoding them to derive corresponding separate left side frames stored as the frame data 333L and right side frames stored as the frame data 333R. The processor circuit 350 is also caused to operate the camera 111 to recurringly capture images of viewers of the viewing device 1000 for facial recognition, storing indications of identified faces as the face data 131 for further processing to identify left and right eye regions, the indications of identified eye regions stored as the eye data 133. The processor circuit 350 is further caused to derive red, green and blue components of each of the left side frames and right side frames buffered in the frame data 333L and 333R, buffering that image data as the image data 539R, 539G and 539B, respectively, for use in driving the image panel(s) 579. The processor circuit 350 is still further caused to determine what eye regions identified in the eye data 133 are to be painted with left side frames or right side frames, storing those determinations as the steering data 739 for use in driving the steering assembly 779. Again, the capture of images of viewers by one or more of the cameras 111 is done recurringly (e.g., multiple times per second) to track changes in the presence and positions of eyes of viewers to recurringly adjust the steering and painting of collimated light to maintain unbroken painting of left and right side frames of to left and right eyes, respectively, of viewers.

In various embodiments, each of the processor circuit 350 may comprise any of a wide variety of commercially available processors, including without limitation, an AMD® Athlon®, Duron® or Opteron® processor; an ARM® application, embedded or secure processor; an IBM® and/or Motorola® DragonBall® or PowerPC® processor; an IBM and/or Sony® Cell processor; or an Intel® Celeron®, Core (2) Duo®, Core (2) Quad®, Core i3®, Core i5®, Core i7®, Atom®, Itanium®, Pentium®, Xeon® or XScale® processor. Further, one or more of these processor circuits may comprise a multi-core processor (whether the multiple cores coexist on the same or separate dies), and/or a multi-processor architecture of some other variety by which multiple physically separate processors are in some way linked.

In various embodiments, the storage 360 may be based on any of a wide variety of information storage technologies, possibly including volatile technologies requiring the uninterrupted provision of electric power, and possibly including technologies entailing the use of machine-readable storage media that may or may not be removable. Thus, each of these storages may comprise any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storages is depicted as a single block, one or more of these may comprise multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller).

In various embodiments, the interface controller 390 may employ any of a wide variety of signaling technologies enabling the computing device 1000 to be coupled to other devices as has been described. Each of these interfaces comprises circuitry providing at least some of the requisite functionality to enable such coupling. However, this interface may also be at least partially implemented with sequences of instructions executed by the processor circuit 350 (e.g., to implement a protocol stack or other features). Where electrically and/or optically conductive cabling is employed, these interfaces may employ signaling and/or protocols conforming to any of a variety of industry standards, including without limitation, RS-232C, RS-422, USB, Ethernet (IEEE-802.3) or IEEE-1394. Where the use of wireless signal transmission is entailed, these interfaces may employ signaling and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1 xRTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc.

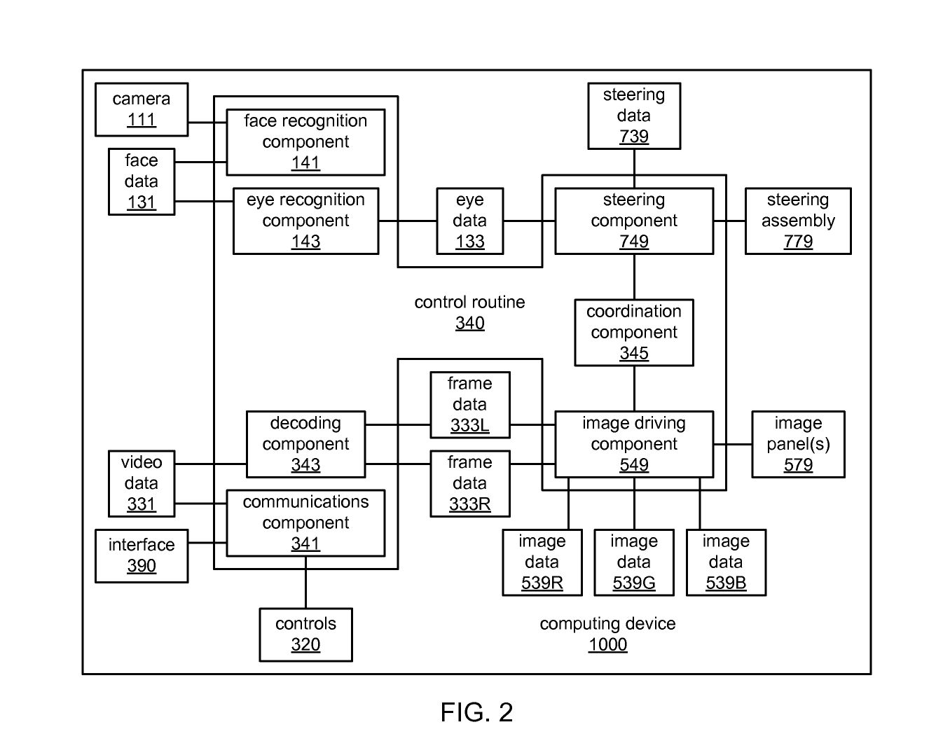

FIG. 2 illustrates, in greater detail, aspects of the operating environment of the processor circuit 350 executing the control routine 340 to perform the aforedescribed functions are depicted. As will be recognized by those skilled in the art, the control routine 340, including the components of which it is composed, implement logic as a sequence of instructions and are selected to be operative on (e.g., executable by) whatever type of processor or processors that are selected to implement each of the processor circuit 350. Stated differently, the term “logic” may be implemented by hardware components, executable instructions or any of a variety of possible combinations thereof. Further, it is important to note that despite the depiction in these figures of specific allocations of implementation of logic between hardware components and routines made up of instructions, other allocations are possible in other embodiments.

In various embodiments, the control routine 340 may comprise a combination of an operating system, device drivers and/or application-level routines (e.g., so-called “software suites” provided on disc media, “applets” obtained from a remote server, etc.). Where an operating system is included, the operating system may be any of a variety of available operating systems appropriate for whatever corresponding ones of the processor circuits 150 and 250, including without limitation, Windows™, OS X™, Linux®, iOS, or Android OS™. Where one or more device drivers are included, those device drivers may provide support for any of a variety of other components, whether hardware or software components, that comprise one or more of the viewing device 1000.

The control routine 340 may incorporate a face recognition component 141 executable by the processor circuit 340 to receive captured images of viewers of the viewing device 1000 from the camera 111 (possibly more than one of the camera 111). The face recognition component 141 employs one or more of any of a variety of face recognition algorithms to identify faces in those captured images, and to store indications of where faces were identified within the field of view of the camera 111 as the face data 131, possibly along with bitmaps of each of those faces. The control routine 340 may also incorporate an eye recognition component 143 executable by the processor circuit 340 to parse the face data 131 and/or employ one or more additional techniques (e.g., shining infrared light towards faces of viewers to cause reflections at eye locations) to identify accessible eyes, identify left eyes versus right eyes, identify angles of orientation of pairs of eyes and/or to identify distances between the eyes of each pair of eyes. The eye recognition component 143 stores indications of one or more of these findings as the eye data 133. Again, it is envisioned that the capturing of images of viewers, the identification of faces and the identification of accessible eyes is done recurringly (possibly many times per second) to recurringly update the eye data 133 frequently enough to enable the presentation of left side frames and right side frames to left eyes and right eyes, respectively, to be maintained despite movement of the eyes of the viewers relative to the viewing device 1000 over time. The intention is to enable a viewer to be continuously provided with a 3D viewing experience as they shift about while sitting on furniture and/or move about a room, as long as they continue to look in the direction of the viewing device 1000.

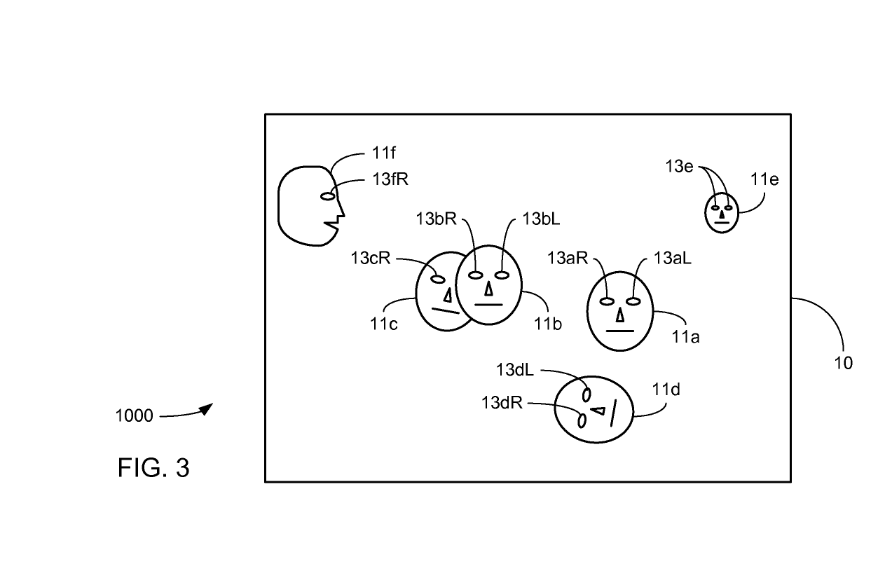

Turning to FIG. 3, an example is presented of multiple faces 11a through 11f captured by the camera 111 in its field of view 10. The field of view 10 of the camera 111 is selected to substantially overlap at least the area that can be painted with collimated light by the steering assembly 779. This enables the camera 111 to be used to identify the locations of eye regions to be painted with collimated light by the steering assembly 779. Stated differently, if an eye is not visible within the field of view 10 of the camera 111, then it cannot be identified as an eye region to be painted with collimated light by the steering assembly 779.

As can be seen, the face 11a presents possibly the simplest case for face and eye recognition, being a single face that neither overlaps or is overlapped by another face, being oriented towards the camera 111 such that the front of the face 11a is captured entirely, and being oriented such that its eyes 13aL and 13aR are aligned in a substantially horizontal orientation. The face recognition component 141 may store indications of orientations of each of the faces 11a-f as part of the face data 131 to assist the eye recognition component 143 in at least determining that the eyes 13aL and 13aR are aligned in a substantially horizontal orientation such that the eye recognition component 143 is able to determine that the eye 13aR is indeed the right eye of the face 11a and that the eye 13aL is the left eye of the face 11a. The eye recognition component 143 then stores an indication of this pair of eyes having been found in the eye data 133, along with indications of which is the left eye and which is the right eye.

However, although the face 11a may have been relatively simple to identify and determine the eye-related aspects of, the faces 11b and 11c present one possible example of difficulty, given that the face 11b partially overlaps the face 11c in the field of view 10. The face 11b, itself, presents much the same situation as did the face 11a. The face 11b is oriented towards the camera 111 such that both of its eyes 13bL and 13bR are visible, and the eyes 13bL and 13bR are aligned in a substantially horizontal orientation. However, only part of the face 11c is visible, and more significantly, only its right eye 13cR is visible. In some embodiments, the face recognition component 141 may analyze the image of the face 11c to determine whether it is the left side or the right side of the front of the face 11c that is visible in the field of view 10 as part of enabling a determination of whether it is a left eye or a right eye that is visible, however, this may be unnecessary. As those skilled in the art of human 3D visual perception will readily recognize, when one eye of a person is obscured, the visual information that is able to be obtained by the other eye lacks depth perception such that it is effectively only a two-dimensional (2D) image of whatever the unobscured eye sees that is ultimately perceived by that person. Thus, identifying whether it is a left eye or a right eye of the face 11c that is visible to the camera 111 in the field of view 10 may be immaterial, since the lack of visibility of both eyes of the face 11c renders presenting 3D imagery to the eyes of the face 11c impossible.

In response to this, the face recognition component 141 may note the location and partially obscured nature of the face 11c in the face data 131, but make no determination and/or leave no indication of whether it is the left or right side that is visible. The eye recognition component 143 may then determine that only one eye of the face 11c is visible. This may result, as will be explained in greater detail, in the eye region of the eye 13cR being painted with only left side imagery or right side imagery, or imagery created from the left and right side imagery by any of a variety of techniques. Where either left side or right side imagery, rather than imagery created from both, is to be painted to the one visible eye of the face 11c, then it may be deemed desirable to determine whether the one visible eye is a left eye or a right eye, and thus, the face recognition component 141 may still determine whether it is the left side or the right side of the face 11c that is visible to enable a determination of whether it is a left eye or a right eye that is visible on the face 11c. Alternatively, a random selection may be made between painting the one visible eye with left side imagery or a right side imagery (more specifically, the eye recognition component 143 may randomly determine that the one visible eye, the eye 13cR, is a left eye or a right eye).

The face 11d may present another difficult situation, given that the face 11d is oriented substantially sideways such that the eyes 13dL and 13dR are aligned in an orientation that is substantially vertical, or at least quite far from being horizontal. Although the face 11d is oriented towards the camera 111 such that both of its eyes are visible, the fact of their substantially vertical alignment calls into question whether 3D imagery may be effectively presented to that pair of eyes and/or whether attempting to do so may provide an unpleasant viewing experience to that person. Given the human tendency to view much of the world with eyes aligned in a substantially horizontal orientation, much of available 3D imagery is created with a presumption that it will be viewed with pairs of eyes in a substantially horizontal alignment. Thus, despite both of the eyes 13dL and 13dR being visible to the camera 111, painting those eyes with collimated light conveying separate left side and right side imagery may be disorienting to the viewer with the face 11d, given that the orientation of their eyes creates depth perception based on vertically perceived differences between the fields of view of each of the eyes 13dL and 13dR when looking at anything else around them other than the viewing device 1000, while the imagery that would be provided from the viewing device 1000 to those eyes would be based on horizontally perceived differences. In other words, the viewer with the face 11d, due to the substantially vertical alignment of their eyes 13dL and 13dR, views their environment with a rotated parallax in which their left and rights eyes are effectively operating as “upper” and “lower” eyes, respectively. It may be deemed desirable, instead of continuing to paint this viewer's eyes with separate left and right side frames, to respond to this substantially vertical alignment of the eyes 13dL and 13dR by painting both with the same left side imagery, the same right side imagery, or imagery created from both left and rights side imagery. Stated differently, it may be deemed desirable to provide the eyes 13dL and 13dR with 2D imagery, rather than 3D, just as in the case of the single visible eye of the face 11c. As another possible alternative, the frame data 333L and 333R may be employed to generate a 3D model of the 3D imagery that they represent and then alternative “upper” and “lower” frames may be generated from that 3D model, and ultimately caused to be projected towards the eye regions of the eyes 13dL and 13dR of the face 11d, thus providing this particular viewer with 3D viewing in which the parallax has been rotated to better align with their rotated parallax.

The face 11e may present still another difficult situation, given the further distance of the face 11e away from the vicinity of the viewing device 1000, as indicated by its smaller size relative to the other faces visible in the field of view 10. It is envisioned that the steering assembly 779 may be limited in its accuracy to aim the painting of collimated light and/or there may be limits in the ability to control the spreading of the collimated light over longer distances from the steering assembly 779 to a face such that it may not be possible to effectively paint the two eyes of someone further away from the location of the steering assembly 779 with separate left side and right side imagery. As a result, the eye recognition component 143 may treat the two eyes of the face 11e as only a single eye region if the face 11e is determined to be sufficiently small that it must be sufficiently far away that a single painting of collimated light will paint both eyes at once. Alternatively, the eye recognition component 143 may cause both eyes to be painted with the same imagery (e.g., both to painted with left side imagery, or right side imagery, or imagery created from frames of both left and right sides).

The face 11f presents still another difficult situation, given that the face 11f is not oriented towards the camera 111, but is in profile relative to the camera 111. As a result, and similar to the situation of the face 11c, only one of the eyes of the face 11f is visible to the camera 111 in the field of view 10. This situation may be responded to in a manner similar to the manner in which the situation of the face 11c is responded to. Imagery may be painted to the one eye 13fR that is either a randomly selected one of left side imagery or right side imagery, or the face recognition component 141 may include an algorithm to determine whether the side of the face 11f visible to the camera 111 is the left side or the right side from analyzing such a profile view to enable imagery of the corresponding side to be selected. Alternatively, imagery created from both left and right side imagery may be used.

Returning to FIG. 2, the control routine 340 may incorporate a steering component 749 executable by the processor circuit 350 to drive the steering assembly 779 to separately paint left side imagery and right side imagery to different eye regions of each of the faces of the viewers of the viewing device 1000. The steering component 749 recurringly parses the indications of identified left and right eye locations in the eye data 133 to recurringly derive eye regions to which the steering assembly 779 is to steer collimated light conveying one or the other of left and right side imagery in each instance of steering.

The control routine 340 may incorporate a communications component 341 executable by the processor circuit 350 to operate the interface 390 at least to receive 3D video imagery from a network and/or RF transmission, as has been previously discussed. The communications component 341 may also be operable to receive commands indicative of operation of the controls 320 by a viewer of the viewing device 1000, especially where the controls 320 are disposed in a casing separate from much of the rest of the viewing device 1000, as in the case of the controls 320 being incorporated into a remote control where infrared and/or RF signaling is received by the interface 390 therefrom. The communications component buffers frames of the received video imagery as the video data 331. The control routine 340 may also incorporate a decoding component 343 executable by the processor circuit 350 to decode frames of the buffered video imagery of the video data 331 (possibly also to decompress it) to derive corresponding left side frames and right side frames of the received video imagery, buffering the left side frames as the frame data 333L and buffering the right side frames as the frame data 333R.

The control routine 340 may incorporate an image driving component 549 executable by the processor circuit 350 to drive the image panel(s) 579 with red, green and blue components of the left side frames and right side frames that are buffered in the frame data 333L and the frame data 333R, respectively. The image driving component 549 recurringly retrieves left side and right side frames from the frame data 333L and 333R, and separates each into red, green and blue components, buffering them as the image data 539R, 539G and 539B. The image driving component 549 then retrieves these components, and drives separate ones of the image panel(s) 579 with these red, green and blue components. It should be noted that although a separation into red, green and blue components is discussed and depicted throughout in a manner consistent with a red-green-blue (RGB) color encoding, other forms of color encoding may be used, including and not limited to luminance-chrominance (YUV).

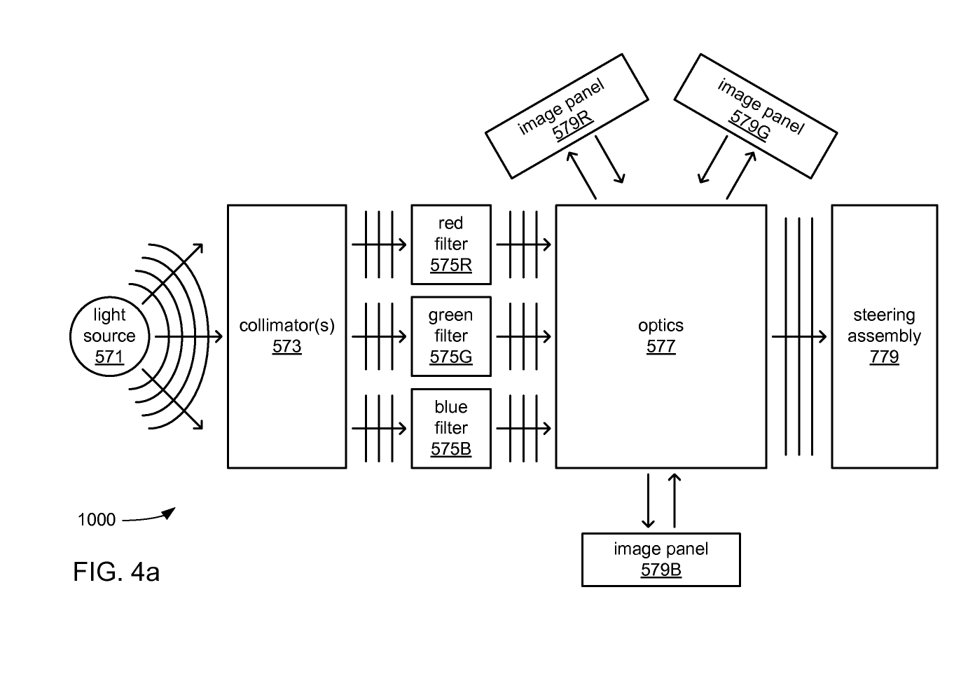

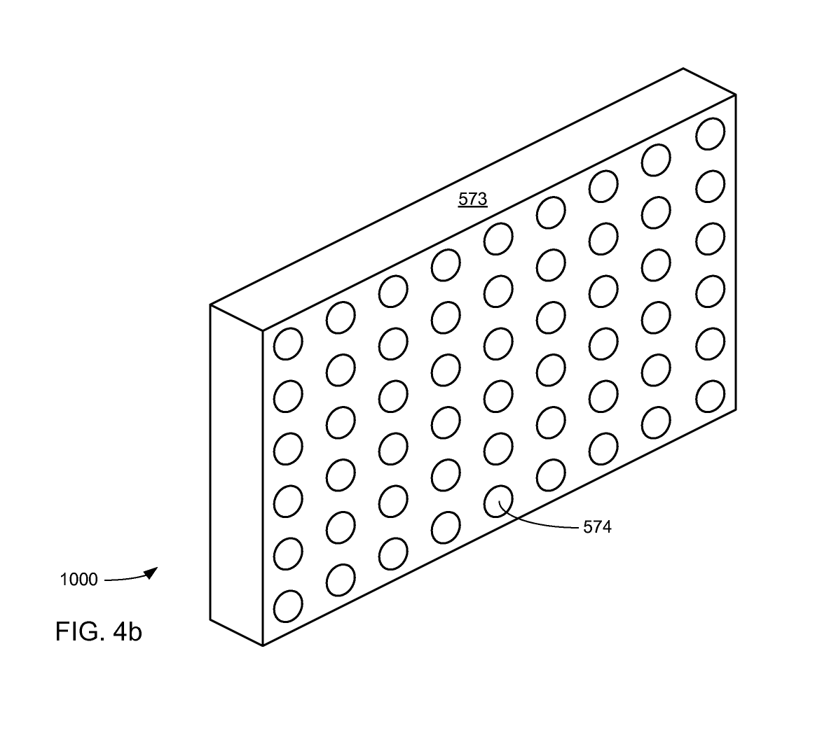

Turning to FIGS. 4a and 4b, an example is presented of one possible selection and arrangement of optical and optoelectronic components to create collimated light, cause the collimated light to convey left side and right side frames of 3D imagery, and steer the collimated light towards eye regions of viewers. It should be emphasized that despite this specific depiction of specific relative positioning of components to manipulate light in various ways, other arrangements of such components are possible in various possible embodiments. As depicted in FIG. 4a, a light source 571 emits non-collimated light that is then spatially collimated by the collimator 573. Separate portions of the now collimated light is then passed through different ones of three of the filters 575, specifically a red filter 575R, a green filter 575G and a blue filter 575B to narrow the wavelengths of the collimated light that will be used to three selected wavelengths or three relatively narrow selected ranges of wavelengths that correspond to the colors red, green and blue. These separate selected wavelengths or selected ranges of wavelengths of colored collimated light are then redirected by the optics 577 towards corresponding ones of the image panel(s) 579, specifically an image panel 579R for red, an image panel 579G for green and an image panel 579B for blue. As depicted, each of the image panels 579R, 579G and 579B are selectively reflective image panels providing a two-dimensional grid of independently controllable minor surfaces (at least one per pixel) to selectively reflect or not reflect portions of the colored collimated light directed at each of them. As a result, the colored collimated light reflected back towards the optics 577 by each of these image panels now conveys pixels of a component (red, green or blue) of a left side frame or right side frame of imagery. The colored collimated light reflected back from each of these three image panels is then combined by the optics 577, thereby combining the color components of each pixel by aligning corresponding pixels of the red, green and blue reflected collimated light to create a multicolored collimated light conveying the now fully colored pixels of that left side frame or right side frame of imagery, which the optics 577 directs toward the steering assembly 779. The steering assembly employs an two-dimensional array of MEMS-based micro minors or other separately controllable optical elements to separately direct each pixel of the left side frame or right side frame of imagery towards a common eye region for a period of time at least partly determined by a refresh rate and the number of eye regions to be painted.

Given the provision of collimation by the collimator(s) 573, the light source 571 may be any of a variety of light sources that may be selected for characteristics of the spectrum of visible light wavelengths it produces, its power consumption, its efficiency in producing visible light vs. heat (infrared), etc. Further, although only one light source 571 is depicted and discussed, the light source 571 may be made up of an array of light sources, such as a two-dimensional array of light-emitting diodes (LEDs).

As depicted in FIG. 4b, the collimator(s) 573 may be made up of a sheet of material through which nanoscale apertures 574 are formed to collimate at least selected wavelengths of the light produced by the light source 571. It may be that the apertures 574 are formed with three separate diameters, each of the three diameters selected to be equal to half a desired wavelength of a red wavelength, a blue wavelength and a green wavelength to specifically effect collimation of light of those particular wavelengths. As those skilled in the art will readily recognize, other wavelengths of light will pass through the apertures 574, but will not be as effectively collimated as the light at the wavelengths to which the diameters of the apertures 574 have been tuned in this manner. Turning back to FIG. 4a, the collimator(s) 573 may be made up of three side-by-side collimators, each with a different one of the three diameters of the apertures 574, and each positioned to cooperate with a corresponding one of the three filters 575R, 575G and 575B, respectively, to create three separate wavelengths (or narrow ranges of wavelengths) of colored collimated light—one red, one green and one blue. Alternatively, the collimator(s) 573 may be made up of a single collimator through which the apertures 574 are formed with different ones of the three diameters in different regions of such a single collimator, with the regions positioned to align with corresponding ones of the three filters 575R, 575G and 575B. The collimator(s) 573, whether made up of a single collimator or multiple ones, may be fabricated from silicon using technologies of the semiconductor industry to form the apertures 574.

The optics 577 may be made up of any of a wide variety of possible combinations of lenses, mirrors (curved and/or planar), prisms, etc., required to direct each of the three wavelengths (or narrow ranges of wavelengths) of colored collimated light just described to a corresponding one of the image panels 579R, 579G and 579B, and then to combine those three forms of colored collimated light as selectively reflected back from each of those image panels into the multicolored collimated light conveying a left side frame or a right side frame of imagery that the optics 577 direct toward the steering assembly 779. The optics 577 may include a grid of lenses and/or other components to further enhance the quality of collimation of light, possibly pixel-by-pixel, at any stage between the collimator(s) 573 and the steering assembly 779.

As has been discussed, each of the image panels 579R, 579G and 579B are positioned and/or otherwise configured to selectively reflect collimated light in a manner based on the red, green and blue components, respectively, of the pixels of a left side frame or a right side frame of imagery. Specifically, each of these three panels may be fabricated using liquid crystal on silicon (LCOS) technology or a similar technology to create grids of separately operable reflectors, each corresponding to a pixel. However, in another possible embodiment (not shown), each of the image panels 579R, 579G and 579B may be selectively conductive, instead of selectively reflective, and placed in the path of travel of each of the three wavelengths (or narrow ranges of wavelengths) of colored collimated light emerging from the collimator(s) 573 and corresponding ones of the filters 575R, 575G and 575B. Specifically, each of these three panels may be made up of a liquid crystal display (LCD) panel through which the red, green and blue wavelengths (or narrow ranges of wavelengths) of colored collimated light are passed, and by which selective (per-pixel) obstruction of those wavelengths (or narrow ranges of wavelengths) of colored collimated light results in the conveying of the color components of each of pixel of a left side frame or a right side frame of imagery in that light. Whether selectively reflective or selectively conductive, each of the three image panels 579R, 579G and 579B may be based on any of a variety of technologies enabling selective conductance or reflection of light on a per-pixel basis.

The steering assembly 779 is made up of a two-dimensional array of individually steerable micro-mirrors (one per pixel) to individually steer individual portions of the multicolored collimated light corresponding to individual pixels of a left side frame or a right side frame towards a common eye region. Alternatively or additionally, electro-optical effects of materials (such as a Pockels or a Kerr effect) may be employed such that the steering assembly 779 is made up of a two-dimensional array of individual pieces of transparent material (one per pixel) in which the index of refraction is individually controllable to steer individual pixels of the multicolored collimated light towards a common eye region. Alternatively or additionally, transparent magnetically-responsive liquid or viscous lenses may be employed that may be individually shaped by magnetic fields to steer individual pixels of the multicolored collimated light towards a common eye region.

Returning to FIG. 2, the control routine 340 may incorporate a coordination component 345 executable by the processor circuit 350 to coordinate actions among multiple ones of the components of the control routine 340 to coordinate the driving of red, green and blue components of a left side frame or a right side frame by the image panel(s) 579 with the steering of the multicolored collimated light conveying that left side frame or that right side frame towards an eye region of a left eye or a right eye, respectively, of a viewer. In this way, at least for viewers with both eyes visible to the camera 111, left side frames of 3D imagery are caused to be painted to left eye regions and right side frames of that 3D imagery are caused to be painted to right eye regions.

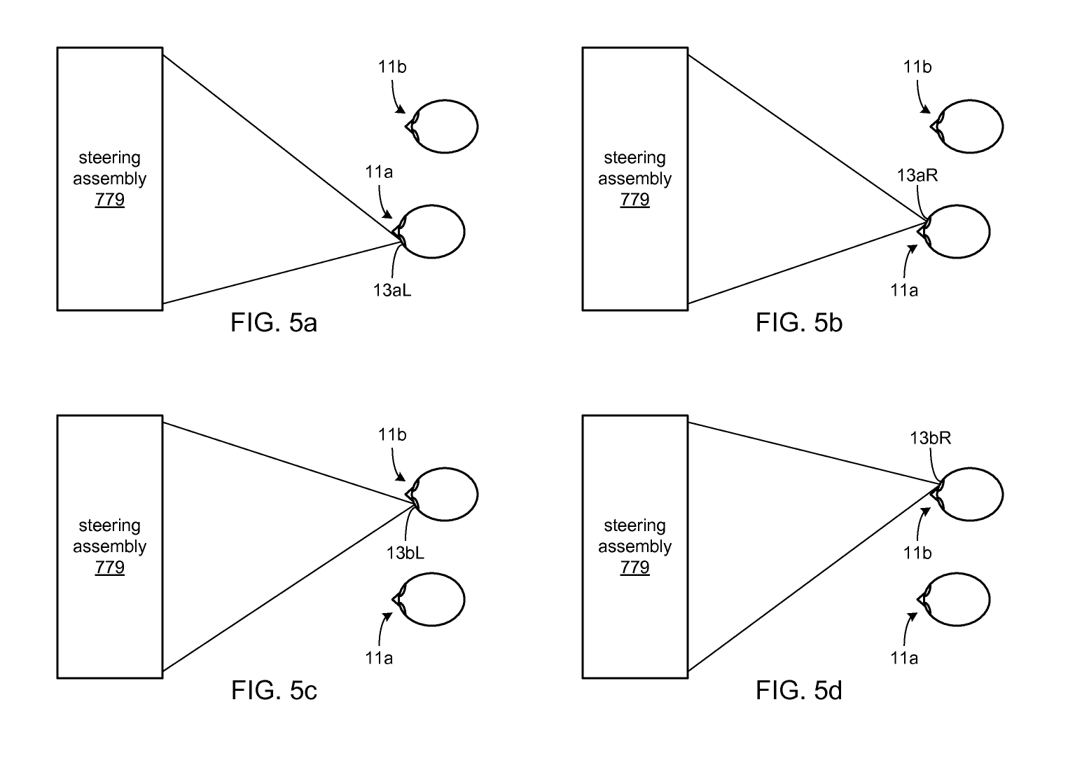

Turning to FIGS. 5a through 5d, and example is presented of one possible order in which the left and right eye regions of two of the faces 11a and 11b (originally presented in FIG. 3) are painted with collimated light that alternately conveys a left side frame or a right side frame of a 3D image thereto. Starting in FIG. 5a, the image panels 579R, 579G and 579B are driven to selectively reflect or not reflect pixels of red, green and blue components of a left side frame of a 3D image to convey those components of that left side frame in reflected forms of the red, green and blue colored collimated light that are directed towards the optics 577. These three reflected forms of red, green and blue collimated light are assembled by the optics 577 into a single multicolor collimated light conveying that left side frame of that 3D image to the steering assembly 779. The individual micro mirrors (or other per-pixel steering elements) of the steering assembly 779 each steer their respective ones of the pixels of the multicolored collimated light towards an eye region of the left eye 13aL of the face 11a.

Then, in FIG. 5b, the image panels 579R, 579G and 579B are driven to selectively reflect or not reflect pixels of red, green and blue components of a right side frame of the same 3D image to convey those components of that right side frame in reflected forms of the red, green and blue colored collimated light that are directed towards the optics 577. These three reflected forms of red, green and blue collimated light are assembled by the optics 577 into a single multicolor collimated light conveying that right side frame of that 3D image to the steering assembly 779. The individual micro mirrors (or other per-pixel steering elements) of the steering assembly 779 each steer their respective ones of the pixels of the multicolored collimated light towards an eye region of the right eye 13aR of the face 11a.

Then, in FIG. 5c, the image panels 579R, 579G and 579B are again driven to selectively reflect or not reflect to again instill red, green and blue components of the same left-side frame of the same 3D image in the red, green and blue collimated light reflected towards the optics 577 for assembly into a multicolored collimated light to direct to the steering assembly 779. The steering assembly 779 is then driven to individually direct each pixel of the multicolored collimated light conveying the left side frame towards the region of the left eye 13bL of the face 11b. And then, in FIG. 5d, the image panels 579R, 579G and 579B are again driven to selectively reflect or not reflect to again instill red, green and blue components of the same right-side frame of the same 3D image in the red, green and blue collimated light reflected towards the optics 577 for assembly into a multicolored collimated light to direct to the steering assembly 779. The steering assembly 779 is then driven to individually direct each pixel of the multicolored collimated light conveying the right side frame towards the region of the right eye 13bR of the face 11b.

Thus, in this example, all of the eye regions of each face that are visible to the camera 111 are painted with an appropriate one of left side frame or right side frame corresponding to a frame of a 3D image, before eye regions of another face are painted. Thus, for each pair of left side and right side frames corresponding to a frame of 3D imagery, the eye regions of all eyes visible to the camera 111 of each face is painted, one face at a time. If the frame rate of the received video data 331 is 30 frames per second, then all of the eye regions of each eye that is visible to the camera 111 are painted with either a left side frame or a right side frame corresponding to a frame of 3D imagery stored in the video data 331 thirty times a second. Therefore, the number of paintings of eye regions every second depends on the frame rate of the video data 331 and the number of eyes visible to the camera 111 among all of the viewers who are viewing the viewing device 1000.

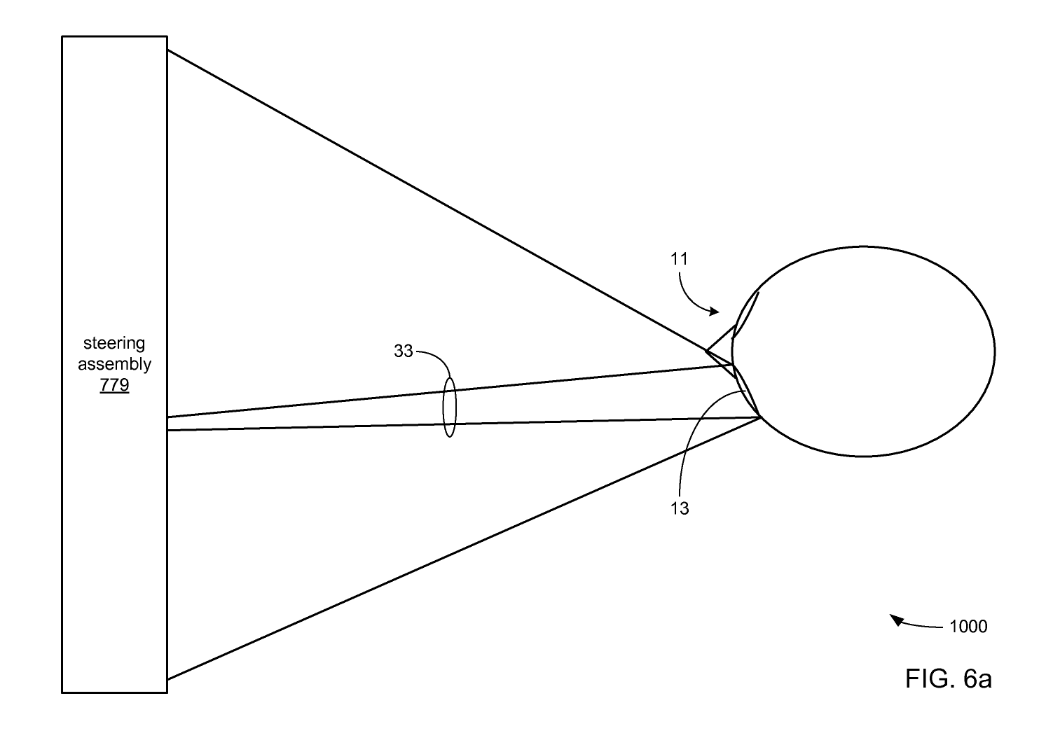

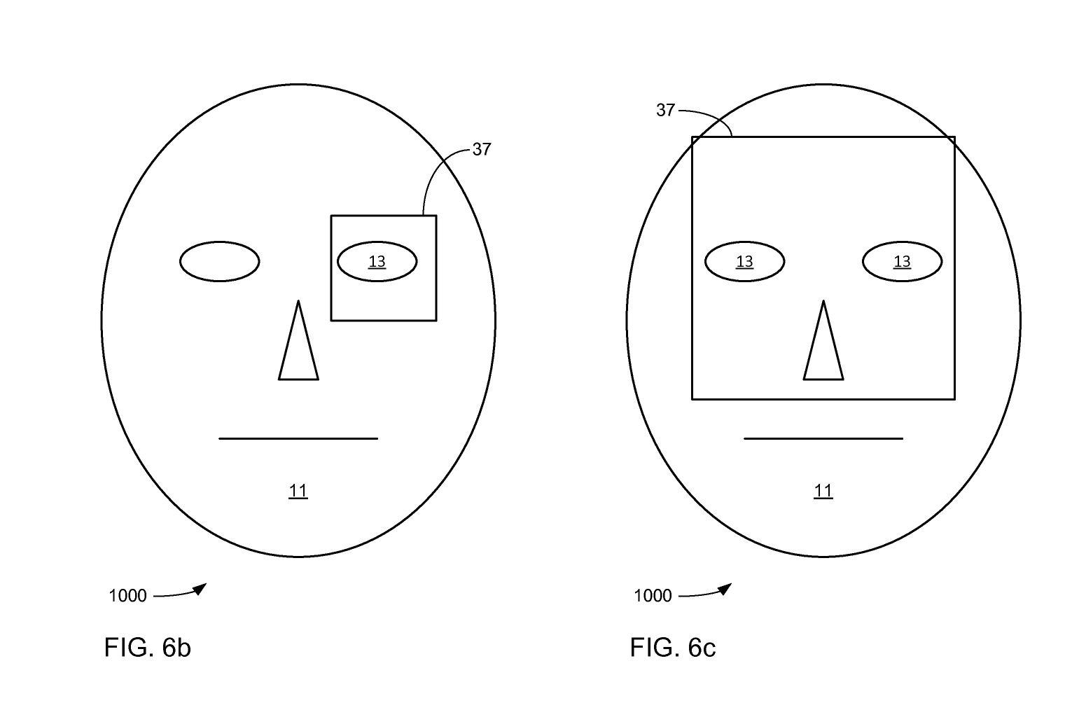

FIGS. 6a through 6c depict various aspects of the steering of each pixel of the multicolored collimated light towards an eye region of an eye 13 of an example face 11. As is known to those familiar with the properties of light, a beam of collimated light spreads to a predictable and calculable degree as it travels, even in a vacuum. Indeed, an amount of spread of the collimated light conveying each pixel of each frame is actually desirable and is advantageously used, especially in the path from the steering assembly 779 to the faces of viewers. FIG. 6a depicts the path and slight spread of collimated light 33 of one pixel from the steering assembly 779 to the eye 13 of the face 11. As can be seen in FIG. 6a, and more clearly in FIG. 6b, the collimated light 33 of the one pixel is allowed to spread sufficiently along this path that it paints a region 37 of the face 11 that is actually somewhat larger than the actual location of the eye 13. In other words it paints an eye region 37 associated with the eye 13, and not just the eye 13, or a portion of the eye 13 (e.g., its pupil). This is done in recognition of the likelihood of there being limitations to the accuracy of the many individual per-pixel steering elements of the steering assembly 779. This also allows for the steering of collimated light towards a particular eye to not have to be adjusted as frequently for each slight subconscious movement of a head that is likely to occur while the human brain moves the human eye (and to some degree, the human head) to take in different parts of the 3D imagery being presented by the viewing device 1000.

It should be noted for the sake of clarity in understanding that the depicted eye region 37 is to be painted not just by the collimated light 33 of the one pixel discussed with regard to these FIGS. 6a-c, but is to be painted by the collimated light of all of the pixels. Stated differently, the individual steering elements for each pixel of the left side or right side frame conveyed by collimated light through the steering assembly 779 are all operated to steer the collimated light of their respective pixels towards the very same eye region 37. Thus the collimated light of each pixel is intended to spread along its path from the steering assembly 779 and to overlap with the collimated light of each other pixel in painting the eye region 37.

The angle of the spread of the collimated light 33 of the one pixel is selected to be likely to create the eye region 37 on the face 11 with a horizontal width that is preferred to be no larger than half the width of the distance between the centers of the eyes of the average person (approximately 2.5 inches) at the average distance at which most persons position their faces from a viewing device (e.g., a television) when viewing motion video (approximately 10 feet). In other words, an angle of spread of the collimated light 33 of the one pixel is selected to achieve a balance between 1) painting a wide enough eye region 37 of a typically-sized face 11 at average distance from the steering assembly 779 to ensure that the pupil of the eye 13 meant to be painted is highly likely to be included in the eye region 37, and 2) painting the eye region 37 too wide such that it becomes all too likely that the pupils of both eyes will be painted with the same left side frame or right side frame such that the ability to provide 3D viewing is lost. It is envisioned, that with such a degree of spread, the accuracy required of the steering assembly 779 to effectively position the eye region 37 to be highly likely include the pupil of only one of the eyes 13 at such a typical viewing distance would require a quarter degree accuracy in the steering of the collimated light 33 of the one pixel.

FIG. 6c depicts how the spread of the collimated light 33 of the one pixel can result in the painting of both eyes 13 of the face 11 at a considerably greater distance from the steering assembly 779 (e.g., the problem described with regard to the face 11e in FIG. 3). As can be seen, given a selected spread in the collimated light 33, the eye region 37 can become wide enough to cover both of the eyes 13 of the face 11 at a sufficiently long distance from the steering assembly 779. As previously discussed, a possible solution would be to treat the pair of the eyes 13 almost as if they were one eye, assigning the single region 37 to both of the eyes 13, and painting both of them with a single frame of 3D imagery (either randomly selecting to use left side frames or right side frames, or using a frame created from both left side and right side frames). Although it may be that a variant of the steering elements for each pixel steered by the steering assembly 779 may be augmented with functionality to control this angle of spread (e.g., per-pixel lenses), it is envisioned that, where possible, the angle of spread of the collimated light of each pixel is set by the quality of collimation of the collimated light conveyed through the steering assembly 779 to avoid the expense and complexity of such additional components.

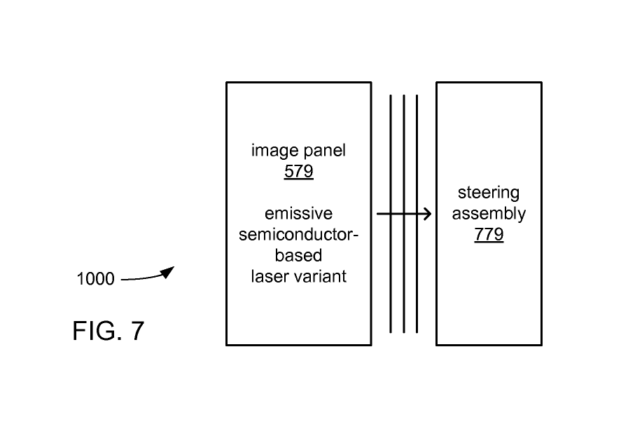

FIG. 7 depicts an alternate possible combination of optical and optoelectronic components to accomplish the generation of collimated light that alternately convey left side and right side frames of 3D imagery and that is alternately steered to paint left side and right side eye regions of the faces of multiple persons. In this variant, collimated light is generated by a variant of a single image panel 579 made up of a two-dimensional grid of semiconductor-based laser (at least one triplet of red, green and blue ones per pixel) that emits multicolored collimated light conveying the left side or right side frame as a result of selective emission of such light for each pixel (instead of using selective reflection or conductance, as discussed above). The collimated light output of this variant of a single image panel 579 is directed, possibly with no interposed optics whatsoever, toward the steering assembly 779 for steering of each pixel of collimated light in the manner that has already been described.

To provide a degree of safety in the painting of eye regions with collimated light generated in this manner, the individual LEDs may require being driven with relatively low power and/or may require modification to introduce an amount of spread in their light output that would be greater than typical of laser LEDs. Alternatively or additionally, some form of diffusion-inducing optics may be interposed between such a variant of a single image panel 579 and the steering assembly 779.

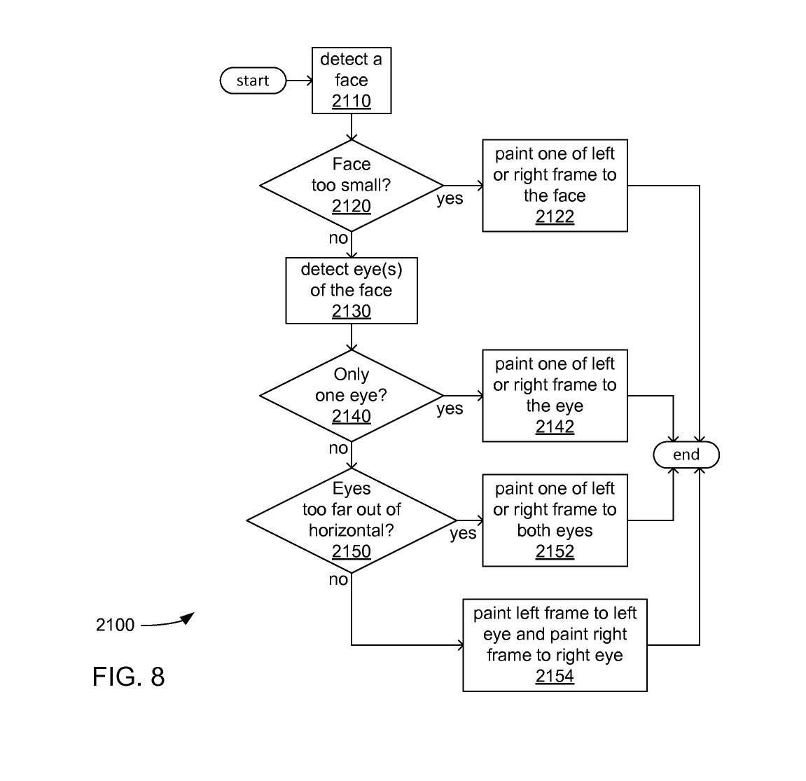

FIG. 8 illustrates an embodiment of a logic flow 2100. The logic flow 2100 may be representative of some or all of the operations executed by one or more embodiments described herein. More specifically, the logic flow 2100 may illustrate operations performed by components of the viewing device 1000, including the processor circuit 350 in executing at least the control routine 340 and/or components of the viewing device 1000.

At 2110, a viewing device (e.g., the viewing device 1000) detects a face in a field of view of at least one camera. As has been discussed, one or more facial recognition algorithms may be employed to identify faces of viewers present in captured images of the field of view of a camera (e.g., the camera 111).

At 2120, a check is made as to whether the face is too small to enable painting of eye regions of that face with collimated light conveying left side frames and right side frames separately to each eye of that face effectively enough to provide 3D viewing. If the face is too small, then one of the left side frame or the right side frame is selected to paint both eyes of that face to provide 2D viewing, instead of 3D, at 2122. Alternatively, as has been discussed, such a face may be painted with frames created from both left side and right side frames. However, if the face is not too small, then at 2130, the eyes of the face are detected.

At 2140, a check is made as to whether only one eye is visible to the camera in the captured image. If only one eye is visible, then one of the left side frame or the right side frame is selected to paint the one visible eye of that face to provide 2D viewing, instead of 3D, at 2142. As has been discussed, that selection may be made randomly or may be made based on a determination of whether the visible portion of the face that includes the visible eye is the left side of the face (such that the visible eye is the left eye) or is the right side of the face (such that the visible eye is the right eye). Alternatively, as has been discussed, such a face may be painted with frames created from both left side and right side frames.

However, if not just one eye is visible, then at 2140, a check is made as to whether the alignment of the two eyes of the face is oriented at too great of an angle away from horizontal. If that orientation is too far from horizontal, then one of the left side frame or the right side frame is selected to paint both eyes of that face to provide 2D viewing, instead of 3D, at 2152. Alternatively, as has been discussed, such a face may be painted with frames created from both left side and right side frames, or the eyes are separately provided “upper” and “lower” frames derived from the left side frame and right side frames likely defined in the received video data (in other words, frames representing a rotation of the parallax of the received 3D imagery). However, if the alignment of the pair of eyes of the face is not oriented at too great an angle from horizontal, then the left eye is painted with left side frames and the right eye is painted with right side frames at 2154.

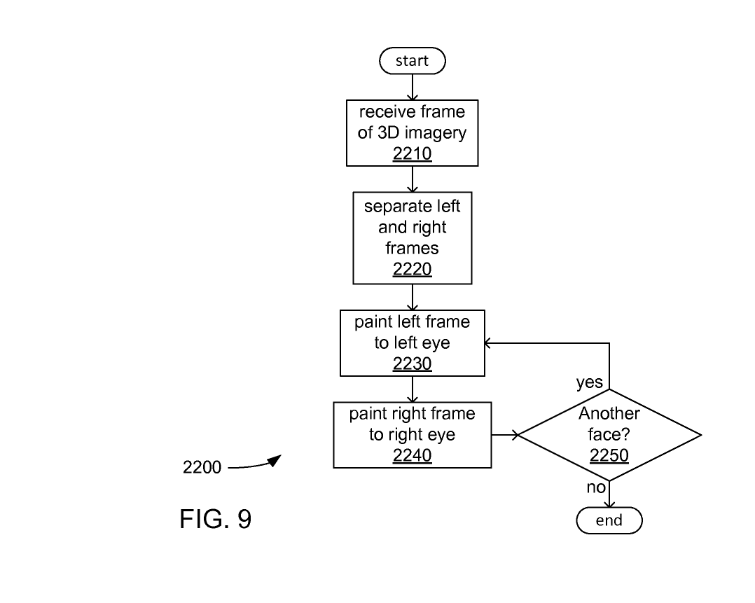

FIG. 9 illustrates an embodiment of a logic flow 2200. The logic flow 2200 may be representative of some or all of the operations executed by one or more embodiments described herein. More specifically, the logic flow 2200 may illustrate operations performed by components of the viewing device 1000, including the processor circuit 350 in executing at least the control routine 340 and/or components of the viewing device 1000.

At 2210, a viewing device (e.g., the viewing device 1000) receives a frame of 3D imagery of 3D motion video. As has been discussed, such video data may be received either via a network or via RF transmission in analog or digitally encoded form over the air or via electrically or optically conductive cabling.

At 2220, the received frame of 3D imagery is decoded to separate a left side frame from a right side frame. As has been discussed, the left side frames and the right side frames may be separately buffered.

At 2230, the viewing device paints the left side frame to a left eye region with collimated light conveying the pixels of the left side frame to the left eye region. As has been discussed, a spread in the collimated light conveying each pixel is selected to balance being highly likely to cause the pupil of the eye of the painted eye region to be covered while also not causing too wide an eye region to be painted on a face that it becomes highly likely that the pupils of both eyes will be covered.

At 2240, the viewing device paints the right side frame to a right eye region with collimated light conveying the pixels of the right side frame to the right eye region. It should be noted that despite discussion herein of painting an eye region associated with a left eye before painting an eye region associated with a right eye, this order can be reversed—there is no particular need or reason to start with either the left side or the right side. A check is made at 2250 as to whether there is another face, and if so, then the left side frame is painted to the left eye region of that next face at 2230.

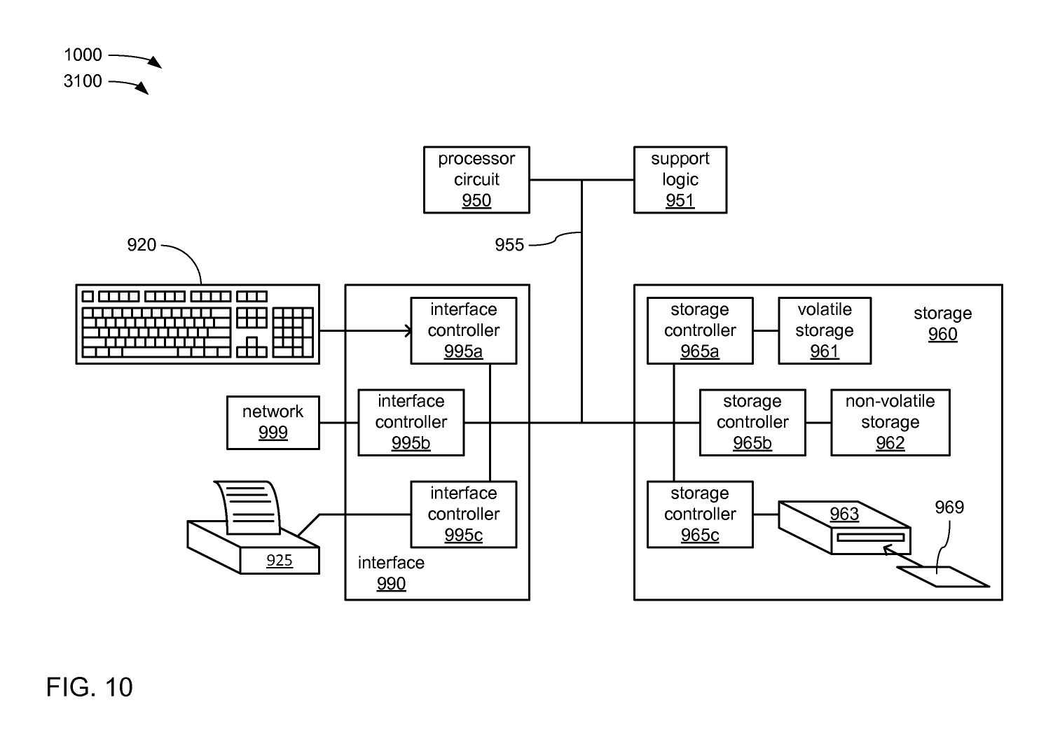

FIG. 10 illustrates an embodiment of an exemplary processing architecture 3100 suitable for implementing various embodiments as previously described. More specifically, the processing architecture 3100 (or variants thereof) may be implemented as part of the computing device 1000, and/or within the controller 200. It should be noted that components of the processing architecture 3100 are given reference numbers in which the last two digits correspond to the last two digits of reference numbers of components earlier depicted and described as part of each of the computing device 1000 and the controller 200. This is done as an aid to correlating such components of whichever ones of the computing device 1000 and the controller 200 may employ this exemplary processing architecture in various embodiments.

The processing architecture 3100 includes various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted exemplary processing architecture. For example, a component can be, but is not limited to being, a process running on a processor circuit, the processor circuit itself, a storage device (e.g., a hard disk drive, multiple storage drives in an array, etc.) that may employ an optical and/or magnetic storage medium, an software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to one or more signal lines. A message (including a command, status, address or data message) may be one of such signals or may be a plurality of such signals, and may be transmitted either serially or substantially in parallel through any of a variety of connections and/or interfaces.

As depicted, in implementing the processing architecture 3100, a computing device comprises at least a processor circuit 950, support logic 951, a storage 960, a controller 900, an interface 990 to other devices, and coupling 955. As will be explained, depending on various aspects of a computing device implementing the processing architecture 3100, including its intended use and/or conditions of use, such a computing device may further comprise additional components, such as without limitation, a camera 910 comprising a flash 915, an audio subsystem 970 comprising an audio amplifier 975 and an acoustic driver 971, and a display interface 985.

Coupling 955 is comprised of one or more buses, point-to-point interconnects, transceivers, buffers, crosspoint switches, and/or other conductors and/or logic that communicatively couples at least the processor circuit 950 to the storage 960. Coupling 955 may further couple the processor circuit 950 to one or more of the interface 990, the camera 910, the audio subsystem 970 and the display interface 985 (depending on which of these and/or other components are also present). With the processor circuit 950 being so coupled by couplings 955, the processor circuit 950 is able to perform the various ones of the tasks described at length, above, for whichever ones of the computing device 1000 and the controller 200 implement the processing architecture 3100. Coupling 955 may be implemented with any of a variety of technologies or combinations of technologies by which signals are optically and/or electrically conveyed. Further, at least portions of couplings 955 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor circuit 950 (corresponding to the processor circuit 350) may comprise any of a wide variety of commercially available processors, employing any of a wide variety of technologies and implemented with one or more cores physically combined in any of a number of ways.

As previously discussed, the storage 960 (corresponding to the storage 360) may comprise one or more distinct storage devices based on any of a wide variety of technologies or combinations of technologies. More specifically, as depicted, the storage 960 may comprise one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 as possibly comprising multiple distinct types of storage is in recognition of the commonplace use of more than one type of storage device in computing devices in which one type provides relatively rapid reading and writing capabilities enabling more rapid manipulation of data by the processor circuit 950 (but possibly using a “volatile” technology constantly requiring electric power) while another type provides relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 955 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and comprises one or more ferromagnetic and/or solid-state disk drives, the non-volatile storage 962 may be communicatively coupled to coupling 955 through a storage controller 965b providing an appropriate interface to the non-volatile storage 962 that perhaps employs addressing of blocks of information and/or of cylinders and sectors. By way of still another example, where the removable media storage 963 is present and comprises one or more optical and/or solid-state disk drives employing one or more pieces of machine-readable storage medium 969 (possibly corresponding to the storage medium 169), the removable media storage 963 may be communicatively coupled to coupling 955 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage medium 969.

One or the other of the volatile storage 961 or the non-volatile storage 962 may comprise an article of manufacture in the form of a machine-readable storage media on which a routine comprising a sequence of instructions executable by the processor circuit 950 may be stored, depending on the technologies on which each is based. By way of example, where the non-volatile storage 962 comprises ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to storage medium such as a floppy diskette. By way of another example, the non-volatile storage 962 may comprise banks of solid-state storage devices to store information, such as sequences of instructions, in a manner akin to a compact flash card. Again, it is commonplace to employ differing types of storage devices in a computing device at different times to store executable routines and/or data. Thus, a routine comprising a sequence of instructions to be executed by the processor circuit 950 may initially be stored on the machine-readable storage medium 969, and the removable media storage 963 may be subsequently employed in copying that routine to the non-volatile storage 962 for longer term storage not requiring the continuing presence of the machine-readable storage medium 969 and/or the volatile storage 961 to enable more rapid access by the processor circuit 950 as that routine is executed.

As previously discussed, the interface 990 (possibly corresponding to the interface 390) may employ any of a variety of signaling technologies corresponding to any of a variety of communications technologies that may be employed to communicatively couple a computing device to one or more other devices. Again, one or both of various forms of wired or wireless signaling may be employed to enable the processor circuit 950 to interact with input/output devices (e.g., the depicted example keyboard 920 or printer 925) and/or other computing devices, possibly through a network (e.g., the network 999) or an interconnected set of networks. In recognition of the often greatly different character of multiple types of signaling and/or protocols that must often be supported by any one computing device, the interface 990 is depicted as comprising multiple different interface controllers 995a, 995b and 995c. The interface controller 995a may employ any of a variety of types of wired digital serial interface or radio frequency wireless interface to receive serially transmitted messages from user input devices, such as the depicted keyboard 920. The interface controller 995b may employ any of a variety of cabling-based or wireless signaling, timings and/or protocols to access other computing devices through the depicted network 999 (perhaps a network comprising one or more links, smaller networks, or perhaps the Internet). The interface 995c may employ any of a variety of electrically conductive cabling enabling the use of either serial or parallel signal transmission to convey data to the depicted printer 925. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, laser printers, inkjet printers, mechanical robots, milling machines, etc.

Where a computing device is communicatively coupled to (or perhaps, actually comprises) a display (not depicted) in addition to the various components already discussed above for visually presenting 3D imagery, such a computing device implementing the processing architecture 3100 may also comprise the display interface 985. Although more generalized types of interface may be employed in communicatively coupling to a display, the somewhat specialized additional processing often required in visually displaying various forms of content on a display, as well as the somewhat specialized nature of the cabling-based interfaces used, often makes the provision of a distinct display interface desirable. Wired and/or wireless signaling technologies that may be employed by the display interface 985 in a communicative coupling of the display 980 may make use of signaling and/or protocols that conform to any of a variety of industry standards, including without limitation, any of a variety of analog video interfaces, Digital Video Interface (DVI), DisplayPort, etc.

More generally, the various elements of the computing device 1000 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

An example of a device includes an image panel to cause collimated light to convey multiple pixels of one of a left side frame and a right side frame associated with a frame of a three-dimensional (3D) image, and a steering assembly to steer the collimated light towards an eye to paint an eye region of a face that includes the eye.

The above example of a device, in which the image panel includes one of a reflective image panel formed from liquid crystal on silicon technology to selectively reflect the collimated light, a conductive image panel formed from liquid crystal display technology to selectively conduct the collimated light, and an emissive image panel formed for light-emitting diode laser technology to selectively emit the collimated light.

Either of the above examples of a device, in which the steering assembly includes a two-dimensional grid of steering elements, each steering element corresponding to a pixel of the multiple pixel, and each steering element comprising one of a micro-mirror, and transparent material with a controllable index of refraction.

Any of the above examples of a device, in which the device includes a light source to provide light and a collimator to provide the collimated light from the light provided by the light source.

Any of the above examples of a device, in which the collimator includes silicon through which a multitude of apertures are formed.

Any of the above examples of a device, in which each aperture of the multitude of apertures formed to have one of three diameters, each of the three diameters selected to tune at least one apertures of the multitude of apertures to collimate light of one of a wavelength of red light, a wavelength of green light and a wavelength of blue light.

Any of the above examples of a device, in which the device includes an interface to receive the frame of the 3D image from one of a network and a radio-frequency broadcast.

Any of the above examples of a device, in which the device includes a camera, and logic to identify the face and the eye in an image captured by the camera, the field of view of the camera overlapped by the eye region.

Any of the above examples of a device, in which the device includes a display to visually present a two-dimensional image of the frame of the 3D image.

An example of another device includes a camera to capture an image of a face in a field of view of the camera, and a steering assembly to steer collimated light to paint a first eye region of the face with the collimated light, the collimated light caused to convey pixels of one of a left side frame and a right side frame associated with a frame of a three-dimensional (3D) image.

The above example of another device, in which the device includes a processor circuit, and logic to identify the face in the image, and identify a first eye on the face.

Either of the above examples of another device, in which the logic is to determine that the first eye is the only eye of the face visible to the camera, determine whether the first eye is a left eye or a right eye of the face, cause the collimated light to convey pixels of the left side frame in response to a determination that the first eye is the left eye of the face, and cause the collimated light to convey pixels of the right side frame in response to a determination that the first eye is the right eye of the face.

Any of the above examples of another device, in which the logic is to determine that the face is too far from the steering assembly to enable the first eye to be painted with the collimated light without a painting of a second eye of the face with the collimated light, and cause the collimated light to convey pixels of one of the left side frame and the right side frame to both the first and second eyes simultaneously.

Any of the above examples of another device, in which the logic is to determine that an alignment of the first eye and a second of the face is oriented substantially vertically, and cause the collimated light to convey pixels of one of the left side frame and the right side frame to both the first and second eyes.

Any of the above examples of another device, in which the logic is to determine that an alignment of the first eye and a second of the face is oriented substantially vertically, derive an upper frame and a lower frame of the frame of the 3D image, and cause the collimated light to convey pixels of the upper frame to one of the first and second eyes, and to convey pixels of the lower frame to another of the first and second eyes.

Any of the above examples of another device, in which the device includes an interface to receive the frame of the 3D image from one of a network and a radio-frequency broadcast, and logic to separate the left side frame and the right side frame from a frame of the 3D imagery.

Any of the above examples of another device, in which the device includes a display to visually present a two-dimensional image of the frame of the 3D image.

An example of a computer-implemented method includes capturing an image of a face, identifying a first eye of the face, and painting a first eye region of the face that covers the first eye with collimated light conveying pixels of one of a left side frame and a right side frame associated with a frame of a three-dimensional (3D) image.

The above example of a computer-implemented method, in which the method includes identifying a second eye of the face, and painting a second eye region of the face that covers the second eye with collimated light conveying pixels of another of the left side frame and the right side frame.

Either of the above examples of a computer-implemented method, in which the method includes determining that the first eye is the only eye of the face visible to the camera, determining whether the first eye is a left eye or a right eye of the face, causing the collimated light to convey pixels of the left side frame in response to determining that the first eye is the left eye of the face, and causing the collimated light to convey pixels of the right side frame in response to determining that the first eye is the right eye of the face.

Any of the above examples of a computer-implemented method, in which the method includes determining that the face is too far from a steering assembly to enable the first eye to be painted with the collimated light without painting a second eye of the face with the collimated light, and causing the collimated light to convey pixels of one of the left side frame and the right side frame to both the first and second eyes simultaneously.

Any of the above examples of a computer-implemented method, in which the method includes determining that an alignment of the first eye and a second of the face is oriented substantially vertically, and causing the collimated light to convey pixels of one of the left side frame and the right side frame to both the first and second eyes.

Any of the above examples of a computer-implemented method, in which the method includes visually presenting a two-dimensional image of the frame of the 3D image on a display.

An example of at least one machine-readable storage medium includes instructions that when executed by a computing device, cause the computing device to capture an image of a face in a field of view of a camera, and steer collimated light to paint a first eye region of the face with the collimated light, the collimated light caused to convey pixels of one of a left side frame and a right side frame associated with a frame of a three-dimensional (3D) image.

The above example of at least one machine-readable storage medium, in which the computing device is caused to identify the face in the image and identify a first eye on the face.

Either of the above examples of at least one machine-readable storage medium, in which the computing device is caused to determine that the first eye is the only eye of the face visible to the camera, determine whether the first eye is a left eye or a right eye of the face, cause the collimated light to convey pixels of the left side frame in response to a determination that the first eye is the left eye of the face, and cause the collimated light to convey pixels of the right side frame in response to a determination that the first eye is the right eye of the face.

Any of the above examples of at least one machine-readable storage medium, in which the computing device is caused to determine that the face is too far from the steering assembly to enable the first eye to be painted with the collimated light without a painting of a second eye of the face with the collimated light, and cause the collimated light to convey pixels of one of the left side frame and the right side frame to both the first and second eyes simultaneously.

Any of the above examples of at least one machine-readable storage medium, in which the computing device is caused to determine that an alignment of the first eye and a second of the face is oriented substantially vertically, and cause the collimated light to convey pixels of one of the left side frame and the right side frame to both the first and second eyes.

Any of the above examples of at least one machine-readable storage medium, in which the computing device is caused to visually present a two-dimensional image of the frame of the 3D image on a display of the computing device.

1. A device comprising:
an image panel to cause collimated light to convey multiple pixels of one of a left side frame and a right side frame associated with a frame of a three-dimensional (3D) image; and
a steering assembly to steer the collimated light towards an eye to paint an eye region of a face that includes the eye.

2. The device of claim 1, the image panel comprising one of a reflective image panel formed from liquid crystal on silicon technology to selectively reflect the collimated light, a conductive image panel formed from liquid crystal display technology to selectively conduct the collimated light, and an emissive image panel formed for light-emitting diode laser technology to selectively emit the collimated light.

3. The device of claim 1, the steering assembly comprising a two-dimensional grid of steering elements, each steering element corresponding to a pixel of the multiple pixel, and each steering element comprising one of a micro-mirror, and transparent material with a controllable index of refraction.

4. The device of claim 1, comprising a light source to provide light and a collimator to provide the collimated light from the light provided by the light source.

5. The device of claim 4, the collimator comprising silicon through which a multitude of apertures are formed.

6. The device of claim 5, each aperture of the multitude of apertures formed to have one of three diameters, each of the three diameters selected to tune at least one apertures of the multitude of apertures to collimate light of one of a wavelength of red light, a wavelength of green light and a wavelength of blue light.

7. The device of claim 1, comprising an interface to receive the frame of the 3D image from one of a network and a radio-frequency broadcast.

8. The device of claim 1, comprising:
a camera; and
logic to identify the face and the eye in an image captured by the camera, the field of view of the camera overlapped by the eye region.

9. The device of claim 1, comprising a display to visually present a two-dimensional image of the frame of the 3D image.

10. A device comprising:
a camera to capture an image of a face in a field of view of the camera; and
a steering assembly to steer collimated light to paint a first eye region of the face with the collimated light, the collimated light caused to convey pixels of one of a left side frame and a right side frame associated with a frame of a three-dimensional (3D) image.

11. The device of claim 10, comprising:
a processor circuit; and
logic to:
identify the face in the image; and
identify a first eye on the face.

12. The device of claim 11, the logic to:
determine that the first eye is the only eye of the face visible to the camera;
determine whether the first eye is a left eye or a right eye of the face;
cause the collimated light to convey pixels of the left side frame in response to a determination that the first eye is the left eye of the face; and
cause the collimated light to convey pixels of the right side frame in response to a determination that the first eye is the right eye of the face.

13. The device of claim 11, the logic to:
determine that the face is too far from the steering assembly to enable the first eye to be painted with the collimated light without a painting of a second eye of the face with the collimated light; and
cause the collimated light to convey pixels of one of the left side frame and the right side frame to both the first and second eyes simultaneously.

14. The device of claim 11, the logic to:
determine that an alignment of the first eye and a second of the face is oriented substantially vertically; and
cause the collimated light to convey pixels of one of the left side frame and the right side frame to both the first and second eyes.

15. The device of claim 11, the logic to:
determine that an alignment of the first eye and a second of the face is oriented substantially vertically;
derive an upper frame and a lower frame of the frame of the 3D image; and
cause the collimated light to convey pixels of the upper frame to one of the first and second eyes, and to convey pixels of the lower frame to another of the first and second eyes.

16. The device of claim 10, comprising:
an interface to receive the frame of the 3D image from one of a network and a radio-frequency broadcast; and
logic to separate the left side frame and the right side frame from a frame of the 3D imagery.

17. The device of claim 10, comprising a display to visually present a two-dimensional image of the frame of the 3D image.

18. A computer-implemented method comprising:
capturing an image of a face;
identifying a first eye of the face; and
painting a first eye region of the face that covers the first eye with collimated light conveying pixels of one of a left side frame and a right side frame associated with a frame of a three-dimensional (3D) image.

19. The computer-implemented method of claim 18, comprising:
identifying a second eye of the face; and
painting a second eye region of the face that covers the second eye with collimated light conveying pixels of another of the left side frame and the right side frame.

20. The computer-implemented method of claim 18, comprising:
determining that the first eye is the only eye of the face visible to the camera;
determining whether the first eye is a left eye or a right eye of the face;
causing the collimated light to convey pixels of the left side frame in response to determining that the first eye is the left eye of the face; and
causing the collimated light to convey pixels of the right side frame in response to determining that the first eye is the right eye of the face.

21. The computer-implemented method of claim 18, comprising:
determining that the face is too far from a steering assembly to enable the first eye to be painted with the collimated light without painting a second eye of the face with the collimated light; and
causing the collimated light to convey pixels of one of the left side frame and the right side frame to both the first and second eyes simultaneously.

22. The computer-implemented method of claim 18, comprising:
determining that an alignment of the first eye and a second of the face is oriented substantially vertically; and
causing the collimated light to convey pixels of one of the left side frame and the right side frame to both the first and second eyes.

23. The computer-implemented method of claim 18, comprising visually presenting a two-dimensional image of the frame of the 3D image on a display.

24. At least one machine-readable storage medium comprising instructions that when executed by a computing device, cause the computing device to:
capture an image of a face in a field of view of a camera; and
steer collimated light to paint a first eye region of the face with the collimated light, the collimated light caused to convey pixels of one of a left side frame and a right side frame associated with a frame of a three-dimensional (3D) image.

25. The at least one machine-readable storage medium of claim 24, the computing device caused to:
identify the face in the image; and
identify a first eye on the face.

26. The at least one machine-readable storage medium of claim 25, the computing device caused to:
determine that the first eye is the only eye of the face visible to the camera;
determine whether the first eye is a left eye or a right eye of the face;
cause the collimated light to convey pixels of the left side frame in response to a determination that the first eye is the left eye of the face; and
cause the collimated light to convey pixels of the right side frame in response to a determination that the first eye is the right eye of the face.

27. The at least one machine-readable storage medium of claim 25, the computing device caused to:
determine that the face is too far from the steering assembly to enable the first eye to be painted with the collimated light without a painting of a second eye of the face with the collimated light; and
cause the collimated light to convey pixels of one of the left side frame and the right side frame to both the first and second eyes simultaneously.

28. The at least one machine-readable storage medium of claim 25, the computing device caused to:
determine that an alignment of the first eye and a second of the face is oriented substantially vertically; and
cause the collimated light to convey pixels of one of the left side frame and the right side frame to both the first and second eyes.

29. The at least one machine-readable storage medium of claim 24, the computing device caused to visually present a two-dimensional image of the frame of the 3D image on a display of the computing device.
